(19) United States
(12) Patent Application Publication
(10) Pub. No.: US 2025/0148575 A1
(43) Pub. Date: May 8, 2025

(54) ELECTRONIC DEVICE FOR TRAINING NEURAL NETWORK MODEL PERFORMING IMAGE ENHANCEMENT AND CONTROLLING METHOD THEREOF

(71) Applicant: SAMSUNG ELECTRONICS CO, LTD., Suwon-si (KR)

(72) Inventors: Sanghun KIM, Suwon-si (KR); Bongjoe KIM, Suwon-si (KR)

(73) Assignee: SAMSUNG ELECTRONICS CO, LTD., Suwon-si (KR)

(21) Appl. No.: 19/018,891

(22) Filed: Jan. 13, 2025

Related U.S. Application Data
(63) Continuation of application No. PCT/KR2023/007427, filed on May 31, 2023.

(30) Foreign Application Priority Data
Jul. 13, 2022 (KR) 10-2022-0086218

(51) Int. Cl. G06T 5/60

(52) U.S. Cl. CPC G06T 5/60; G06T 2207/20081; G06T 2207/20084

(57) ABSTRACT

An electronic device includes memory storing instructions; and one or more processors configured to execute the instructions to obtain first loss values by inputting a first training image into neural network models; identify a smallest first loss value from among the first loss values; identify the first training image as being in a first training image group for a first neural network model corresponding to the smallest first loss value; obtain second loss values by inputting a second training image into the neural network models; identify a smallest second loss value from among the second loss values; identify the second training image as being in a second training image group for a second neural network model corresponding to the smallest second loss value; train the first neural network model based on the first training image group; and train the second neural network model based on the second training image group.

### CROSS-REFERENCE TO RELATED APPLICATIONS

This application is a by-pass continuation application of International Application No. PCT/KR2023/007427, filed on May 31, 2023, which is based on and claims priority to Korean Patent Application No. 10-2022-0086218, filed on Jul. 13, 2022, in the Korean Intellectual Property Office, the disclosures of which are incorporated by reference herein in their entireties.

### 1. FIELD

The present disclosure relates to an electronic device and a controlling method thereof, and more particularly to, an electronic device for training each of a plurality of neural network models using loss values of images output from the plurality of neural network models.

### 2. Description of Related Art

With the development of electronic technology, various types of electronic devices are being developed and popularized. In particular, various methods to improve image quality using trained neural network models to provide high-quality images to users are being developed.

Methods such as removing noise in the image, improving sharpness, improving edges, improving resolution, etc. are commonly used in order to improve image quality, and depending on the quality of the image, different methods may be used to improve the image quality. Different neural network models may be used for different image quality improvement methods, and each neural network model may have specialized performance for one of a plurality of image quality improvement methods. In order for each of the neural network models to have unique performance, it is important to train with appropriate training images, so it is important to cluster the training images so that each of the neural network models can be trained for target performance.

### SUMMARY

According to an aspect of the disclosure, an electronic device, for training a neural network model for performing image enhancement, includes memory storing instructions; and one or more processors configured to execute the instructions, wherein the instructions, when executed by the one or more processors, cause the electronic device to obtain a plurality of first loss values by inputting a first training image from among a first plurality of training images into a plurality of neural network models; identify a loss value having a smallest size from among the plurality of first loss values; identify the first training image as being included in a first training image group for a first neural network model, corresponding to the loss value identified from among the plurality of first loss values, from among the plurality of neural network models; obtain a plurality of second loss values by inputting a second training image from among the first plurality of training images into the plurality of neural network models; identify a loss value having a smallest size from among the plurality of second loss values; identify the second training image as being included in a second training image group for a second neural network model, corresponding to the loss value identified from among the plurality of second loss values, from among the plurality of neural network models; and train the first neural network model by inputting a second plurality of training images included in the first training image group into the first neural network model, and train the second neural network model by inputting a third plurality of training images included in the second training image group into the second neural network model.

The instructions, when executed by the one or more processors, may further cause the electronic device to obtain a first plurality of first raw loss values of different types by inputting the first training image into a third neural network model from among the plurality of neural network models; obtain a third loss value from among the plurality of first loss values by applying a first preset weight to the first plurality of first raw loss values; obtain a second plurality of first raw loss values of different types by inputting the first training image into a fourth neural network model from among the plurality of neural network models; and obtain a fourth loss value from among the plurality of first loss values by applying a second preset weight to each of the second plurality of first raw loss values.

The instructions, when executed by the one or more processors, may further cause the electronic device to obtain a first plurality of first raw loss values of different types by inputting the first training image into a third neural network model from among the plurality of neural network models; obtain a first intermediate loss value by applying a first weight corresponding to a fourth neural network model from among the plurality of neural network models to the first plurality of first raw loss values; obtain a first plurality of second raw loss values of different types by inputting the second training image into a fifth neural network model from among the plurality of neural network models; obtain a second intermediate loss value by applying a second weight corresponding to a sixth neural network model from among the plurality of neural network models to the first plurality of second raw loss values; obtain a normalized first intermediate loss value and a normalized second intermediate loss value by normalizing each of the first intermediate loss value and the second intermediate loss value based on the first intermediate loss value and the second intermediate loss value; obtain the plurality of first loss values based on the normalized first intermediate loss value; and obtain the plurality of second loss values based on the normalized second intermediate loss value.

The instructions, when executed by the one or more processors, may further cause the electronic device to normalize each of the first intermediate loss value and the second intermediate loss value based on a distribution shape of each of the first intermediate loss value and the second intermediate loss value.

The first plurality of first raw loss values of different types may include a first L1 loss value and a first Generative Adversarial Networks (GAN) loss value, the first plurality of second raw loss values of different types may include a second L1 loss value and a second GAN loss value, and the instructions, when executed by the one or more processors, may further cause the electronic device to obtain the first intermediate loss value by weighting the first L1 loss value and the first GAN loss value based on a third weight corresponding to a seventh neural network model from among the plurality of neural network models; and obtain the second intermediate loss value by weighting the second L1 loss value and the second GAN loss value based on a fourth weight corresponding to an eighth neural network model from among the plurality of neural network models.

The first plurality of first raw loss values of different types may include a first L1 loss value, a first GAN loss value, and a first span loss value, the first plurality of second raw loss values of different types may include a second L1 loss value, a second GAN loss value, and a second span loss value, and the instructions, when executed by the one or more processors, may further cause the electronic device to obtain the first intermediate loss value by weighting the first L1 loss value, the first GAN loss value, and the first span loss value based on a third weight corresponding to a seventh neural network model from among the plurality of neural network models; and obtain the second intermediate loss value by weighting the second L1 loss value, the second GAN loss value, and the second span loss value based on a fourth weight corresponding to an eighth neural network model from among the plurality of neural network models. The first span loss value and the second span loss value may be calculated based on a loss value between a first output image of a ninth neural network model from among the plurality of neural network models and a second output image of a tenth neural network model from among the plurality of neural network models.

The plurality of neural network models may be trained to reduce loss values obtained based on each of the first training image and the second training image.

The plurality of neural network models may be models that perform image classification and image enhancement, and the instructions, when executed by the one or more processors, may further cause the electronic device to obtain a first plurality of loss values corresponding to the plurality of neural network models by inputting an input image into a third neural network model for predicting a loss value; identify a third loss value having a smallest size from among the first plurality of loss values; and obtain an image by inputting the input image into a fourth neural network model corresponding to the third loss value from among the plurality of neural network models. The third neural network model for predicting the loss value may be trained based on a training image and a second plurality of loss values of the training image for the plurality of neural network models.

The electronic device may further include a display, and the instructions, when executed by the one or more processors, may further cause the electronic device to identify a third neural network model corresponding to the input image from among the plurality of neural network models; obtain an image by inputting the input image to the third neural network model; and control the display to display the image.

According to an aspect of the disclosure, a method of controlling an electronic device, for training a neural network model for performing image enhancement, includes obtaining a plurality of first loss values by inputting a first training image from among a first plurality of training images into a plurality of neural network models; identifying a loss value having a smallest size from among the plurality of first loss values; identifying the first training image as being included in a first training image group for a first neural network model, corresponding to the loss value identified from among the plurality of first loss values, from among the plurality of neural network models; obtaining a plurality of loss values by inputting a second training image from among the first plurality of training images into the plurality of neural network models; identifying a second loss value having a smallest size from among the plurality of second loss values; identifying the second training image as being included in a second training image group for a second neural network model, corresponding to the loss value identified from among the plurality of second loss values, from among the plurality of neural network models; training the first neural network model by inputting a second plurality of training images included in the first training image group into the first neural network model; and training the second neural network model by inputting a third plurality of training images included in the second training image group into the second neural network model.

The obtaining the plurality of first loss values may include obtaining a first plurality of first raw loss values of different types by inputting the first training image into a third neural network model from among the plurality of neural network models; obtaining a third loss value from among the plurality of first loss values by applying a first preset weight to the first plurality of first raw loss values; obtaining a second plurality of first raw loss values of different types by inputting the first training image into a fourth neural network model from among the plurality of neural network models; and obtaining a fourth loss value from among the plurality of first loss values by applying a second preset weight to each of the second plurality of first raw loss values.

The obtaining the plurality of first loss values and the plurality of second loss values may include obtaining a first plurality of first raw loss values of different types by inputting the first training image into a third neural network model from among the plurality of neural network models; obtaining a first intermediate loss value by applying a first weight corresponding to a fourth neural network model from among the plurality of neural network models to the first plurality of first raw loss values; obtaining a first plurality of second raw loss values of different types by inputting the second training image into a fifth neural network model from among the plurality of neural network models; obtaining a second intermediate loss value by applying a second weight corresponding to a sixth neural network model from among the plurality of neural network models to the first plurality of second raw loss values; obtaining a normalized first intermediate loss value and a normalized second intermediate loss value by normalizing each of the first intermediate loss value and the second intermediate loss value based on the first intermediate loss value and the second intermediate loss value; and obtaining the plurality of first loss values based on the normalized first intermediate loss value, and obtaining the plurality of second loss values based on the normalized second intermediate loss value.

The normalizing may include normalizing each of the first intermediate loss value and the second intermediate loss value based on a distribution shape of each of the first intermediate loss value and the second intermediate loss value.

The first plurality of first raw loss values of different types may include a first L1 loss value and a first Generative Adversarial Networks (GAN) loss value, and the first plurality of second raw loss values of different types include a second L1 loss value and a second GAN loss value. The obtaining the first intermediate loss value may include obtaining the first intermediate loss value by weighting the first L1 loss value and the first GAN loss value based on a third weight corresponding to a seventh neural network model from among the plurality of neural network models, and the obtaining the second intermediate loss value may include obtaining the second intermediate loss value by weighting the second L1 loss value and the second GAN loss value based on a fourth weight corresponding to an eighth neural network model from among the plurality of neural network models.

According to an aspect of the disclosure, a non-transitory computer-readable recording medium having instructions recorded thereon, that, when executed by one or more processors, causes the one or more processors to obtain a plurality of first loss values by inputting a first training image from among a first plurality of training images into a plurality of neural network models; identify a loss value having a smallest size from among the plurality of first loss values; identify the first training image as being included in a first training image group for a first neural network model, corresponding to the loss value identified from among the plurality of first loss values, from among the plurality of neural network models; obtain a plurality of second loss values by inputting a second training image from among the first plurality of training images into the plurality of neural network models; identify a loss value having a smallest size from among the plurality of second loss values; identify the second training image as being included in a second training image group for a second neural network model, corresponding to the loss value identified from among the plurality of second loss values, from among the plurality of neural network models; and train the first neural network model by inputting a second plurality of training images included in the first training image group into the first neural network model, and train the second neural network model by inputting a third plurality of training images included in the second training image group into the second neural network model.

The instructions, when executed by the one or more processors, may further cause the one or more processors to obtain a first plurality of first raw loss values of different types by inputting the first training image into a third neural network model from among the plurality of neural network models; obtain a third loss value from among the plurality of first loss values by applying a first preset weight to the first plurality of first raw loss values; obtain a second plurality of first raw loss values of different types by inputting the first training image into a fourth neural network model from among the plurality of neural network models; and obtain a fourth loss value from among the plurality of first loss values by applying a second preset weight to each of the second plurality of first raw loss values.

The instructions, when executed by the one or more processors, may further cause the one or more processors to obtain a first plurality of first raw loss values of different types by inputting the first training image into a third neural network model from among the plurality of neural network models; obtain a first intermediate loss value by applying a first weight corresponding to a fourth neural network model from among the plurality of neural network models to the first plurality of first raw loss values; obtain a first plurality of second raw loss values of different types by inputting the second training image into a fifth neural network model from among the plurality of neural network models; obtain a second intermediate loss value by applying a second weight corresponding to a sixth neural network model from among the plurality of neural network models to the first plurality of second raw loss values; obtain a normalized first intermediate loss value and a normalized second intermediate loss value by normalizing each of the first intermediate loss value and the second intermediate loss value based on the first intermediate loss value and the second intermediate loss value; obtain the plurality of first loss values based on the normalized first intermediate loss value; and obtain the plurality of second loss values based on the normalized second intermediate loss value.

The instructions, when executed by the one or more processors, may further cause the one or more processors to normalize each of the first intermediate loss value and the second intermediate loss value based on a distribution shape of each of the first intermediate loss value and the second intermediate loss value.

The first plurality of first raw loss values of different types may include a first L1 loss value and a first Generative Adversarial Networks (GAN) loss value, wherein the first plurality of second raw loss values of different types include a second L1 loss value and a second GAN loss value, and wherein the instructions, when executed by the one or more processors, further cause the one or more processors to obtain the first intermediate loss value by weighting the first L1 loss value and the first GAN loss value based on a third weight corresponding to a seventh neural network model from among the plurality of neural network models; and obtain the second intermediate loss value by weighting the second L1 loss value and the second GAN loss value based on a fourth weight corresponding to an eighth neural network model from among the plurality of neural network models.

The first plurality of first raw loss values of different types include a first L1 loss value, a first GAN loss value, and a first span loss value, wherein the first plurality of second raw loss values of different types include a second L1 loss value, a second GAN loss value, and a second span loss value, wherein the instructions, when executed by the one or more processors, further cause the one or more processors to obtain the first intermediate loss value by weighting the first L1 loss value, the first GAN loss value, and the first span loss value based on a third weight corresponding to a seventh neural network model from among the plurality of neural network models; and obtain the second intermediate loss value by weighting the second L1 loss value, the second GAN loss value, and the second span loss value based on a fourth weight corresponding to an eighth neural network model from among the plurality of neural network models, and wherein the first span loss value and the second span loss value are calculated based on a loss value between a first output image of a ninth neural network model from among the plurality of neural network models and a second output image of a tenth neural network model from among the plurality of neural network models.

### BRIEF DESCRIPTION OF THE DRAWINGS

The above and other aspects, features, and advantages of certain embodiments of the present disclosure are more apparent from the following description taken in conjunction with the accompanying drawings, in which:

FIGS. 1A and 1B are views provided to schematically explain a method for training a plurality of neural network models according to an embodiment;

FIG. 2 is a block diagram illustrating configuration of an electronic device according to an embodiment;

FIGS. 3A and 3B are views provided to explain a method of obtaining a loss value according to an embodiment;

FIG. 4 is a view provided to explain a method of normalizing a loss value according to an embodiment;

FIGS. 5A and 5B are views provided to explain a method of obtaining an image of which quality has been improved through a trained neural network model according to an embodiment;

FIGS. 6A and 6B are views provided to explain a method of training a plurality of neural network models according to an embodiment;

FIG. 7 is a view provided to explain detailed configuration of an electronic device according to an embodiment; and

FIG. 8 is a flowchart provided to explain a controlling method of an electronic device according to an embodiment.

### DETAILED DESCRIPTION

Hereinafter, example embodiments of the present disclosure will be described in detail with reference to the accompanying drawings.

The terms used in the present disclosure will be briefly described before the present disclosure is described in detail.

General terms that are currently widely used are selected as the terms used in the embodiments of the disclosure in consideration of their functions in the disclosure, but may be changed based on the intention of those skilled in the art or a judicial precedent, the emergence of a new technique, or the like. In addition, in a specific case, terms arbitrarily chosen by an applicant may exist, in which case, the meanings of such terms will be described in detail in the corresponding descriptions of the disclosure. Therefore, the terms used in the embodiments of the disclosure should be defined on the basis of the meanings of the terms and the overall contents throughout the disclosure rather than simple names of the terms.

In the disclosure, the expressions “have”, “may have”, “include” or “may include” indicate existence of corresponding features (e.g., components such as numeric values, functions, operations, or components), but do not exclude presence of additional features.

An expression, “at least one of A or B” should be understood as indicating any one of “A”, “B” and “both of A and B.”

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

Singular expressions include plural expressions unless the context clearly dictates otherwise. Terms such as “comprise,” “include,” and “have” are intended to designate the presence of features, numbers, steps, operations, components, parts, or a combination thereof, but are not intended to exclude in advance the possibility of the presence or addition of one or more of other features, numbers, steps, operations, components, parts, or a combination thereof.

In exemplary embodiments, a “module” or a “unit” may perform at least one function or operation, and be implemented as hardware or software or be implemented as a combination of hardware and software. In addition, a plurality of “modules” or a plurality of “units” may be integrated into at least one module and related functionality may be performed by at least one processor.

In addition, in the present disclosure, ‘deep neural network (DNN)’ is a representative example of an artificial intelligence model that simulates brain nerves, and is not limited to an artificial intelligence neural network model using a specific algorithm.

An embodiment of the present disclosure will be described in greater detail with reference to the accompanying drawings.

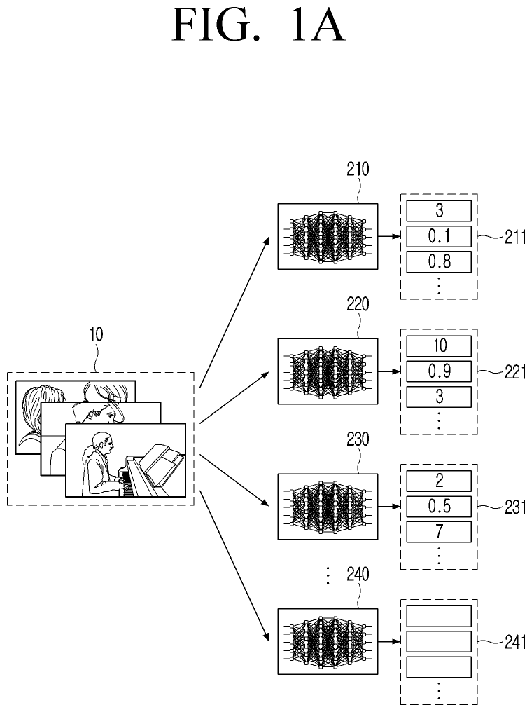

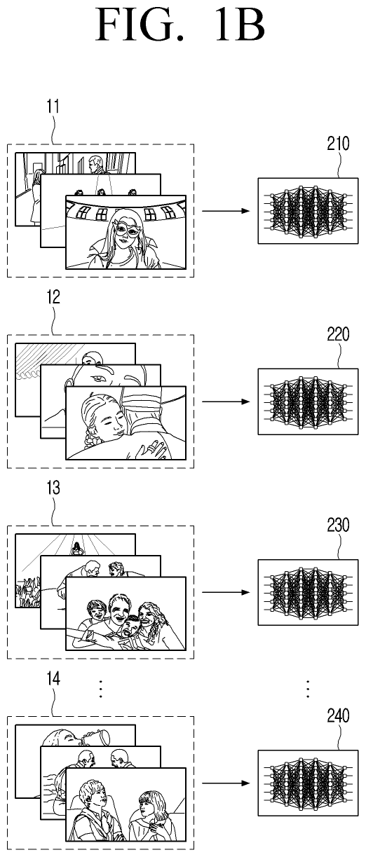

FIGS. 1A and 1B are views provided to schematically explain a method for training a plurality of neural network models according to an embodiment.

An electronic device according to an embodiment may include a plurality of artificial intelligence models (or artificial neural network models or learning network models) consisting of at least one neural network layer. The artificial neural network may include a deep neural network (DNN), such as, but not limited to, a convolutional neural network (CNN), a recurrent neural network (RNN), a restricted Boltzmann machine (RBM), a deep belief network (DBN), a bidirectional recurrent deep neural network (BRDNN), or deep Q-networks.

Further, in the present disclosure, “parameter” is a value used in the operation process of each layer forming a neural network, and may include, for example, a weight used when applying an input value to a preset operation formula. In addition, the parameter may be represented in the form of a matrix. The parameter is a value set as a result of training, and may be updated through separate training data.

An electronic device 100 according to an embodiment may identify a neural network model corresponding to an input image from among a plurality of neural network models, and obtain an image with improved quality by inputting the input image to the neural network model. To this end, the electronic device 100 may train the plurality of neural network models such that each of the plurality of neural network models performs an optimal image enhancement for the input image.

Referring to FIG. 1A, the electronic device 100 according to an embodiment may include a plurality of neural network models 210 to 240. According to an embodiment, the electronic device 100 may input a plurality of training images 10 to each of the plurality of neural network models 210 to 240 to obtain loss values 211, 221, 231, and 241 corresponding to the plurality of training images 10, respectively. Here, the loss value is a value for the difference (distance or error) between the actual correct answer and the value predicted by the neural network model.

For example, when the plurality of training images 10 are input to the neural network model 210, the electronic device 100 may obtain, for each of the plurality of training images 10, a loss value between the image output by the neural network model 210 and the target image (or the correct image or the image with improved quality). In this case, the size of the parameter value of each of the plurality of neural network models 210 to 240 may be different and accordingly, even when the same training image is input, the electronic device 100 may obtain different loss values according to each of the neural network models 210 to 240.

Referring to FIG. 1B, according to an embodiment, the electronic device 100 may identify the plurality of training images 10 as a plurality of training image groups 11 to 14 based on the sizes of the loss values 211, 221, 231, and 241 obtained from the plurality of neural network models 210 to 240. Subsequently, the electronic device 100 may train each of the plurality of neural network models 210 to 240 by inputting the plurality of training image groups 11 to 14 to the neural network models 210 to 240 corresponding to each of the identified plurality of training image groups 11 to 14.

Hereinafter, various embodiments of training each of a plurality of neural network models using a loss value of an image output from the plurality of neural network models and obtaining an image with improved quality using the trained plurality of neural network models will be described.

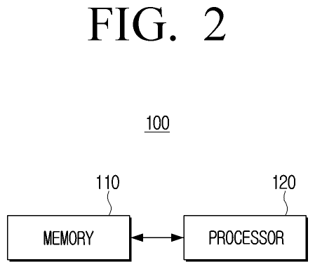

FIG. 2 is a block diagram illustrating configuration of an electronic device according to an embodiment.

The electronic device 100 may be a device that processes images using an artificial intelligence model, such as a TV, a set-top box, a tablet personal computer, a mobile phone, a desktop personal computer, a laptop personal computer, a netbook computer, etc. However, the electronic device 100 is not limited thereto, and the electronic device 100 may be implemented as various types of devices capable of providing content, such as a server, for example, a content providing server, a PC, etc.

The memory 110 may store data required for various embodiments of the present disclosure. The memory 110 may be implemented in the form of memory embedded in the electronic device 100, or it may be implemented in the form of memory removably attached to the electronic device 100, depending on the purpose of storing the data. For example, data for driving the electronic device 100 may be stored in the memory embedded in the electronic device 100, and data for expanding the functionality of the electronic device 100 may be stored in the memory removably attached to the electronic device 100. The memory embedded in the electronic device 100 may be implemented as at least one of volatile memory (e.g., dynamic RAM (DRAM), static RAM (SRAM), or synchronous dynamic RAM (SDRAM), etc.), non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, etc.), a hard drive, or a solid state drive (SSD). In addition, the memory removably attached to the electronic device 100 may be implemented in the form of a memory card (e.g., compact flash (CF), secure digital (SD), micro secure digital (Micro-SD), mini secure digital (Mini-SD), extreme digital (xD), multi-media card (MMC), etc.), external memory connectable to a USB port (e.g., USB memory), etc.

In one example, the memory 110 may store a computer program including at least one instruction or a set of instructions for controlling the electronic device 100.

In one example, the memory 110 may store information about a plurality of neural network (or neural network) models. Here, storing information about a neural network model may mean storing various information related to the operation of the neural network model, such as information about at least one layer included in the neural network model, information about parameters, biases, etc. used in each of the at least one layer, and the like. However, depending on the implementation of a processor 120 which will be described below, information about the neural network model may be stored in the internal memory of the processor 120. For example, if the processor 120 is implemented as dedicated hardware, the information regarding the neural network model may be stored in the internal memory of the processor 120.

The one or more processors 120 (hereinafter, referred to as a processor) may be electrically connected to the memory 110 to control the overall operations of the electronic device 100. The processor 120 may consist of one or multiple processors. The processor 120 may perform the operations of the electronic device 100 according to various embodiments of the present disclosure by executing at least one instruction stored in the memory 110.

The processor 120 according to an embodiment may be implemented as a digital signal processor (DSP) for processing digital signals, a microprocessor, a Graphics Processing Unit (GPU), an Artificial Intelligence (AI) processor, a Neural Processing Unit (NPU), or a Time Controller (TCON). However, the processor 120 is not limited thereto, and may include one or more of a central processing unit (CPU), a Micro Controller Unit (MCU), a micro processing unit (MPU), a controller, an application processor (AP), a communication processor (CP), or an advanced RISC machine (ARM) processor, or may be defined by the corresponding term. Further, the processor 120 may be implemented in a system-on-chip (SoC) or a large scale integration (LSI) in which a processing algorithm is embedded, or may be implemented in the form of a field programmable gate array (FPGA).

The processor 120 according to an embodiment may be implemented as a digital signal processor (DSP) for processing digital signals, a microprocessor, or a Time Controller (TCON). However, the processor 120 is not limited thereto, and may include one or more of a central processing unit (CPU), a Micro Controller Unit (MCU), a micro processing unit (MPU), a controller, an application processor (AP), a communication processor (CP), or an advanced RISC machine (ARM) processor, or may be defined by the corresponding term. Further, the processor 120 may be implemented in a system-on-chip (SoC) or a large scale integration (LSI) in which a processing algorithm is embedded, or may be implemented in the form of a field programmable gate array (FPGA).

In addition, the processor 120 for executing a neural network model according to an embodiment may be implemented through a combination processors such as CPU, AP, or Digital Signal Processor (DSP), dedicated graphics processors such as GPU or Vision Processing Unit (VPU), or dedicated artificial intelligence processors such as NPU and software.

The processor 120 may control to process input data according to a predefined operation rule or a neural network model stored in the memory 110. When the processor 120 is a dedicated processor (or a neural network dedicated processor), the processor 120 may be designed as a hardware structure specialized for processing a neural network model. For example, the hardware specialized for processing a neural network model may be designed as a hardware chip such as an ASIC or an FPGA. When the processor 120 is implemented as a dedicated processor, the processor 120 may be implemented to include memory for implementing an embodiment of the present disclosure, or may be implemented to include a memory processing function for using external memory.

According to an embodiment, the processor 120 may obtain a loss value by inputting a training image to each of a plurality of neural network models. Here, the plurality of neural network models are models that perform image classification and image enhancement functions. For example, the plurality of neural network models may be neural network models that output images with at least one of noise, blur, edge, sharpness, or texture improved. However, the plurality of neural network models are not limited thereto, and may be neural network models that perform processing to convert low-resolution images into high-resolution images through a series of media processing, such as Super Resolution.

In one example, the processor 120 may obtain a loss value corresponding to each neural network model by inputting one of a plurality of training images to each of a plurality of neural network models. For example, the processor 120 may obtain N output images by inputting a first training image to each of N neural network models, and obtain N first loss values for each neural network model based on a difference between the N output images and a corresponding correct image (e.g., a denoised image). For example, the processor 120 may input a second training image that is different from the first training image from among the plurality of training images to each of N neural network models and obtain N second loss values for each neural network model based on a difference between an image output through this and a corresponding correct image (e.g., a deblurred image).

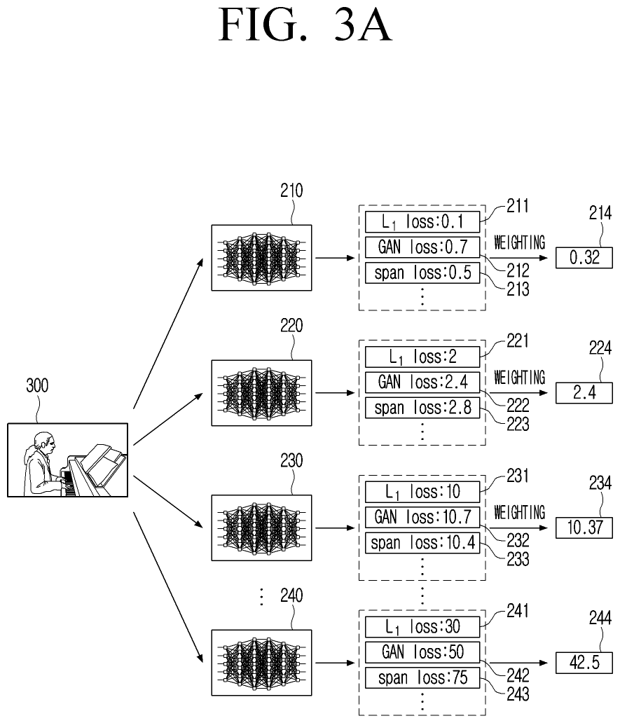

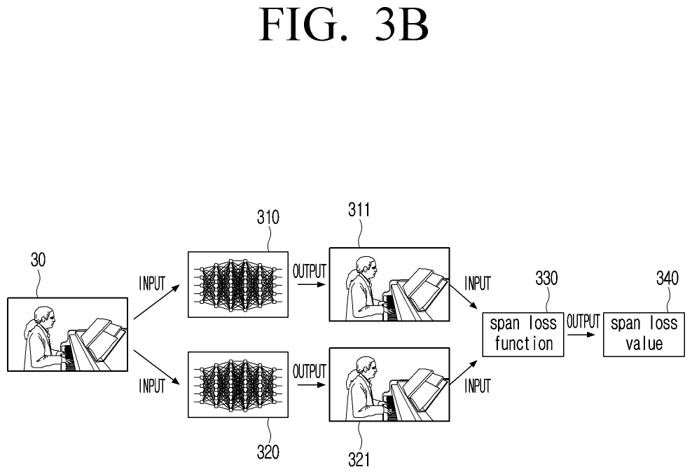

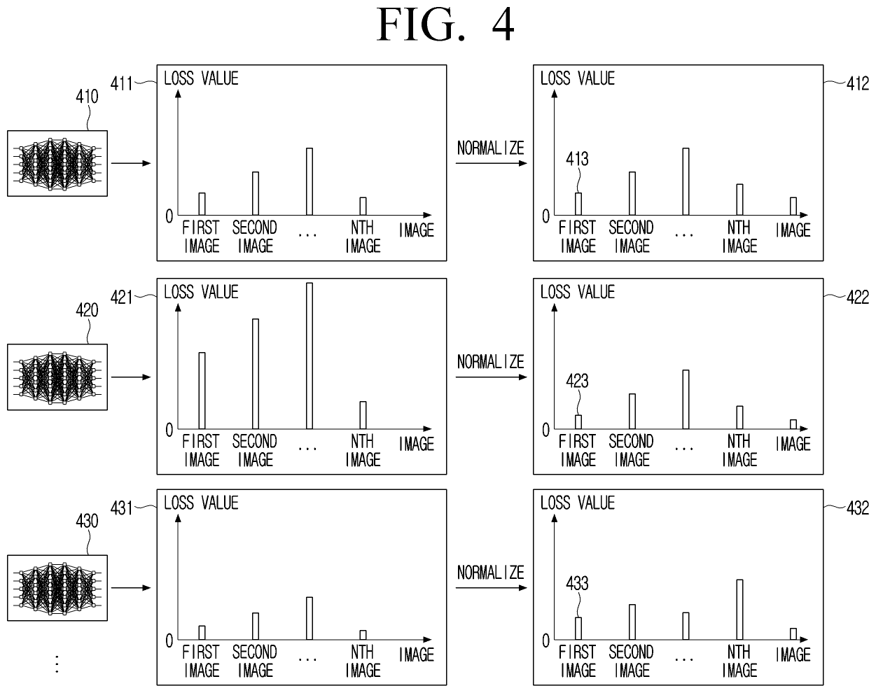

Here, the first loss value and the second loss value refer to loss values corresponding to the first and second training images, respectively. A method for obtaining the first loss value and the second loss value will be described in detail with reference to FIGS. 3A, 3B, and 4.

According to an embodiment, the processor 120 may identify a loss value having the smallest size from among the obtained plurality of loss values. According to an embodiment, the processor 120 may obtain a first loss value corresponding to each of a plurality of neural network models by inputting a first training image to the plurality of neural network models, and identify the first loss value having the smallest size from among the obtained plurality of first loss values.

Here, the reason for identifying the neural network model having the smallest loss value is to identify the neural network model having the smallest difference (or error) between the output image output from each neural network model and the correct image, thereby identifying the neural network model that outputs the image relatively closest to the correct image.

According to an embodiment, the processor 120 may identify training images as a training image group for a neural network model. According to an embodiment, the processor 120 may identify training images as a training image group for a neural network model corresponding to a loss value identified as having the smallest size from among a plurality of neural network models. Here, the training image group refers to a training image group having the smallest loss value corresponding to the identified neural network model from among the plurality of training images.

For example, when the first neural network model corresponding to the smallest loss value from among the loss values of the first training image corresponding to each of the plurality of neural network models is identified, the processor 120 may identify the first training image as the first training image group corresponding to the first neural network model. When the second neural network model corresponding to the smallest loss value from among the loss values of the second training image corresponding to each of the plurality of neural network models is identified, the processor 120 may identify the second training image as the second training image group. In other words, the processor 120 may cluster each of the plurality of training images as a corresponding training image group based on the loss values of the training images.

According to an embodiment, the processor 120 may train a neural network model by inputting training images included in the identified training image group to the neural network model. In one example, the processor 120 may train the first neural network model by inputting at least one training image included in the first training image group to the first neural network model, and may train the second neural network model by inputting at least one training image included in the training image group that is different from the first training image group to the second neural network model.

Here, the training of the neural network model may be accomplished through the electronic device 100, but is not limited thereto, and may also be accomplished through a separate server and/or system. Examples of learning algorithms include, but are not limited to, supervised learning, unsupervised learning, semi-supervised learning, or reinforcement learning.

Accordingly, the electronic device 100 may cluster a plurality of training images into a plurality of training image groups for training a neural network model, and input them into the neural network model to train each neural network model. Therefore, the performance of the neural network model may be rapidly improved.

FIGS. 3A and 3B are views provided to explain a method of obtaining a loss value according to an embodiment.

Referring to FIG. 3A, according to an embodiment, the processor 120 may obtain a raw loss value by inputting a training image to a neural network model. Here, the raw loss value (e.g., first raw loss value or second raw loss value) refers to a loss value used to obtain the first loss value and second loss value described above, which may be at least one of, for example, L1 loss, Generative Adversarial Networks (GAN) loss, or span loss. However, without limitation, the raw loss value may also be a loss value obtained through different types of functions such as L2 loss (or, Mean Squared Error), Root Mean Squared Error (RMSE), Binary Crossentropy, Categorical_Crossentropy, and Sparse_Categorical_Crossentropy. However, for convenience of explanation, the raw loss value is limited to L1 loss, GAN loss, and span loss in the following description.

Here, the L1 loss value (e.g., first L1 loss value or second L1 loss value) is the sum of the absolute values of the errors between the image output through the neural network model and the correct image (Ground Truth), and may be, for example, the sum of the absolute values of the differences between the pixel values (e.g., RGB size values) corresponding to each pixel of the output image and the correct image. According to an example, the processor 120 may calculate the L1 loss value through Equation 1 below.

$$L 1 loss = {\sum }_{( i = 1 )}^{n} \vert {y}_{( i , true )} - {y}_{i , predict} ed \vert \qquad [ Equation 1 ]$$

Here, i refers to the pixel in the image, and n refers to the number of pixels included in the image. γ_{(i,true)} is the size of the pixel value of the i-th pixel included in the correct image, and γ_{i,predict}ed is the size of the pixel value of the i-th pixel included in the output image output through the neural network model. For example, when the output image corresponding to a first training image 300 is obtained through the first neural network model 210, the processor 120 may obtain a first L1 loss value 211 corresponding to the first neural network model 210 of the first training image 300 through Equation 1. However, the present disclosure is not limited thereto, and each of the output image and the L1 loss value may be output through the neural network model.

The trained neural network model 210 to 240 may be a generative adversarial network (GAN) according to an embodiment. The GAN is a network that trains a method of generating false data by competitively training a network (generator, G) that generates false data that is close to the truth and a network (discriminator, D) that discriminates false data. In one example, the processor 120 may calculate a GAN loss value (e.g., first GAN loss value or second GAN loss value) through a GAN loss function such as Equation 2 below.

$${min}_{G} {max}_{D} V ( D , G ) = {E}_{( x} ∼ {p}_{data ( x ) )} [ log D ( x ) ] + {E}_{( z} ∼ {p}_{z ( z ) )} [ log ( 1 - D ( G ( z ) ) ] \qquad [ Equation 2 ]$$

Here, V is the value function, and D refers to the discriminator, G refers to the generator, E refers to the expectation value, and p_{data} (x) refers to the actual data. x refers to a sample image from the actual data, D(x) refers to the probability that the discriminator determines the image as the actual image, G(z) refers to a sample image output from the generator, and D(G(z)) refers to the probability that the discriminator determines the image as the image generated by the generator. p_{z}(z) refers to the uniformly distributed random data, and z is a sample image sampled from the uniform distribution. In one example, the processor 120 may obtain the first GAN loss value corresponding to the first neural network model 210 of the first training image 300 by inputting the first training image 300 to the first neural network model 210. For example, an output image and a first GAN loss value 212 may each be output through the first neural network model 210.

A span loss value (e.g., first span loss value or second span loss value) is calculated based on a loss value between the output image of one of the plurality of neural network models 210 to 240 and the output image of another one of the plurality of neural network models, which will be described in greater detail with reference to FIG. 3B.

According to an embodiment, the processor 120 may obtain a plurality of first raw loss values of different types corresponding to each of the neural network models 210 through 240 by inputting the first training image 300 to the plurality of neural network models 210 to 240. The plurality of first raw loss values corresponding to the first training image may include first L1 loss values 211, 221, . . . , 241, first GAN loss values 212, 222, . . . , 242, and first span loss values 213, 223, . . . , 243. For example, the processor 120 may obtain each of the first L1 loss value 211, the first GAN loss value 212, and the first span loss value 213 corresponding to the first neural network model by inputting the first training image 300 to the first neural network model 210, and obtain each of the first L1 loss value 221, the first GAN loss value 222, and the first span loss value 223 corresponding to the second neural network model by inputting the first training image to the second neural network model 220.

According to an embodiment, the processor 120 may obtain a plurality of second raw loss values of different types corresponding to each of the neural network models 210 through 240 by inputting the second training image to the plurality of neural network models 210 to 240. The plurality of second raw loss values corresponding to the second training image may include the second L1 loss value, the second GAN loss value, and the second span loss value. For example, the processor 120 may obtain each of the second L1 loss value, the second GAN loss value, and the second span loss value corresponding to the first neural network model by inputting the second training image to the first neural network model 210, and obtain each of the second L1 loss value, the second GAN loss value, and the second span loss value corresponding to the second neural network model by inputting the second training image to the second neural network model 220.

However, the present disclosure is not limited thereto, and according to an embodiment, the processor 120 may also obtain at least one of the L1 loss value, the GAN loss value, or the span loss value by inputting the training image to one of the plurality of neural network models. For example, the processor 120 may obtain the first L1 loss value 211 and the first span loss value 213 by inputting the first training image 300 to the first neural network model 210. For example, the processor 120 may obtain the first GAN loss value 212 and the first span loss value 213 by inputting the first training image 300 to the first neural network model 210.

According to an embodiment, the processor 120 may obtain one of a plurality of loss values (e.g., first loss value or second loss value) by applying a preset weight to each of the plurality of raw loss values (e.g., first raw loss value or second raw loss value) corresponding to the training image. Here, the preset weight may have different values based on characteristics of the plurality of neural network models (e.g., noise improvement, blur improvement, sharpness improvement, or texture improvement). In one example, the memory 110 may store a weight corresponding to each of the plurality of neural network models 210 to 240, and the processor 120 may obtain a plurality of first loss values based on the weights stored in the memory 110. The preset weights may be, but are not limited to, values that are pre-stored in the memory 110 at an initial setup, and may be set/changed based on a user command.

In one example, the processor 120 may obtain a first intermediate loss value by applying a weight corresponding to one of the plurality of neural network models 210 to 240 to each of the plurality of first raw loss values. In this case, there may be multiple first intermediate loss values.

For example, it is assumed that the weight corresponding to the first neural network model 210 is (L1 loss: GAN loss: span loss=0.6:0.3:0.1). When the sizes of the first L1 loss value 211, the first GAN loss value 212, and the first span loss value 213 obtained through the first neural network model 210 are 0.1, 0.7, and 0.5, respectively, the processor 120 may multiply the obtained plurality of first raw loss values 211 to 213 by the weight corresponding to the first neural network model 210 to perform weighted sum, and obtain 0.32 (=0.1*0.6+0.7*0.3+0.5*0.1, 214) as the first intermediate loss value corresponding to the first neural network model.

For example, it is assumed that the weight corresponding to the second neural network model 220 is (L1 loss: GAN loss: span loss=0.1:0.8:0.1). When the sizes of the first L1 loss value 221, the first GAN loss value 222, and the first span loss value 223 obtained through the second neural network model 220 are 2, 2.4, and 2.8, respectively, the processor 120 may multiply the obtained plurality of first raw loss values 221 to 223 by the weight corresponding to the second neural network model 220 to perform weighted sum, and obtain 2.4 (=2*0.1+2.4*0.8+2*0.1, 224) as the first intermediate loss value corresponding to the second neural network model 220.

For example, it is assumed that the weight corresponding to the third neural network model 230 is (L1 loss: GAN loss:

$$span loss = \frac{1}{3} : \frac{1}{3} : \frac{1}{3} ) .$$

When the sizes of the first L1 loss value 231, first GAN loss value 232, and first span loss value 233 obtained through the third neural network model 230 are 10, 10.7, and 10.4, respectively, the processor 120 may multiply the obtained plurality of first raw loss values 231 to 233 by the weight corresponding to the third neural network model 230 to perform weighted sum, and obtain 10.37 (=10*1/3+10.7*1/3+10.4*1/3, 234) as the first intermediate loss value corresponding to the third neural network model 230.

In one example, the processor 120 may obtain a second intermediate loss value by applying a weight corresponding to one of the plurality of neural network models 210 through 240 to each of the plurality of second raw loss values. For example, the processor 120 may obtain the second intermediate loss value by weighting a second L1 loss value, a second GAN loss value, and a second span loss value based on a weight corresponding to one of the plurality of neural network models 210 to 240. In this case, there may be multiple second intermediate loss values.

However, the L1 loss value, the GAN loss value, and the span loss value are not necessarily all weighted together, and the processor 120 may obtain an intermediate loss value based on at least one type of raw loss value from among different types of raw loss values. For example, the processor 120 may obtain the intermediate loss value by weighting the L1 loss value and the GAN loss value, and the processor 120 may obtain the span loss value as the intermediate loss value.

FIG. 3B is a view provided to explain a method of obtaining a span loss value according to an embodiment.

Referring to FIG. 3B, according to an embodiment, the processor 120 may obtain a span loss value (e.g., first span loss value or second span loss value) based on a plurality of neural network models. In one example, the processor 120 may obtain an output image 311 from one of the plurality of neural network models 310 and an output image 321 from another one of the plurality of neural network models 320, and obtain a span loss value 340 by calculating the same through a span loss function 330 as in Equation 3 below.

$$spanlossfunction = - {F}_{Loss} ( {FakeHQ}_{1} , {FakeHQ}_{2} ) \qquad [ Equation 3 ]$$

Here, F_{Loss} may be one of the loss functions, such as an L1 loss function, a GAN loss function, an L2 loss (or Mean Squared Error) function, a Root Mean Squared Error (RMSE), or a Binary Crossentropy. FakeHQ₁ refers to an output image from one of the plurality of neural network models, and FakeHQ₂ refers to an output image from another one of the plurality of neural network models. In one example, the processor 120 may input the first training image to each of the first neural network model and the second neural network model to obtain an output image of the first neural network model and an output image of the second neural network model, respectively, and input them into Equation 3 (or span loss function) to obtain a first span loss value corresponding to the first neural network model. In this case, according to an embodiment, the processor 120 may identify the obtained first span loss value as the first span loss value corresponding to the first neural network model, but is not limited to, and may also identify it as the first span loss value corresponding to the second neural network model based on user settings. The neural network model that serves as the anchor for calculating the loss value may vary depending on a user input, and the processor 120 may obtain the first span loss value based on the preset anchor.

Referring back to FIG. 3A, according to an embodiment, the processor 120 may train the plurality of neural network models 210 to 240 such that the plurality of loss values obtained based on each of the first training image and the second training image included in the plurality of training images are reduced. In one example, the processor 120 may train the plurality of neural network models 210 to 240 such that the L1 loss values, the GAN loss values, and the span loss values corresponding to the plurality of neural network models 210 to 240 are reduced. However, the present disclosure is not limited thereto, and the processor 120 may train the plurality of neural network models 210 to 240 such that the obtained intermediate loss value are reduced. The processor 120 may train the plurality of neural network models 210 to 240 such that the obtained loss values (e.g., first loss value or second loss value) are reduced.

In other words, it may be trained that the L1 loss value, the GAN loss value, and the span loss value are reduced. As the neural network models are trained such that the error between the output image of the neural network model and the correct image (ground truth) is reduced, the output image of the neural network model becomes close to the correct image (ground truth). Since the span loss value is a function with a negative sign, it is trained that the error between the output image of one of the neural network models and the output image of another one of the neural network models increases. Accordingly, the output image of one of the neural network models and the output image of another one of the neural network models change as training progresses.

For example, the plurality of neural network models 210 to 240 are trained to reduce the error between the output image of the neural network model and the correct image (ground truth), and increase the error between the output image of one of the plurality of neural network models and the output image of another one of the neural network models.

FIG. 4 is a view provided to explain a method of normalizing a loss value according to an embodiment.

Referring to FIG. 4, according to an embodiment, the processor 120 may obtain a plurality of first raw loss values of different types by inputting the first training image to one of the plurality of neural network models, and may obtain a first intermediate loss value by applying a weight corresponding to one of the plurality of neural network models to each of the plurality of first raw loss values. For example, the processor 120 may obtain the first intermediate loss value corresponding to each of the plurality of neural network models by inputting the first training image to each of the plurality of neural network models.

Further, according to an embodiment, the processor 120 may obtain a plurality of second raw loss values of different types by inputting the second training image to one of the plurality of neural network models, and may obtain a second intermediate loss value by applying a weight corresponding to one of the plurality of neural network models to each of the plurality of second raw loss values. For example, the processor 120 may obtain the second intermediate loss value corresponding to each of the plurality of neural network models by inputting the second training image to each of the plurality of neural network models.

Subsequently, according to an embodiment, the processor 120 may normalize the obtained intermediate loss value based on the obtained intermediate loss value (e.g., the first intermediate loss value or the second intermediate loss value). In one example, the processor 120 may normalize a plurality of intermediate loss values corresponding to each of the plurality of neural network models. In this case, the plurality of intermediate loss values corresponding to each of the plurality of neural network models may include intermediate loss values corresponding to each of a plurality of training images.

In one example, the processor 120 may normalize the intermediate loss values based on the distribution shape of the obtained intermediate loss values. For example, when a plurality of intermediate loss values 411 corresponding to a first neural network model 410 are obtained by inputting each of a plurality of training images (the first image to the nth image) to the first neural network model 410, the processor 120 may obtain a first loss value and a second loss value corresponding to the first neural network model 410 by normalizing the plurality of intermediate loss values corresponding to the first neural network model 410 based on a Gaussian distribution.

In addition, for example, when a plurality of intermediate loss values 421 corresponding to a second neural network model 420 are obtained by inputting each of the plurality of training images (the first image to the nth image) to the second neural network model 420, the processor 120 may obtain a first loss value and a second loss value corresponding to the second neural network model 420 by normalizing the plurality of intermediate loss values corresponding to the second neural network model 420 based on a Gaussian distribution.

Subsequently, according to an embodiment, the processor 120 may identify a loss value having the smallest size from among loss values corresponding to each of the plurality of training images based on normalized loss values 412 to 432. For example, in the case of the loss values 412 to 432 corresponding to the first training image, the loss value having the smallest size may be identified by comparing the size of the normalized first loss value 413 corresponding to the first neural network model 410, the size of the normalized first loss value 423 corresponding to the second neural network model 420, and the size of the normalized first loss value 433 corresponding to the third neural network model 430.

Subsequently, according to an embodiment, the processor 120 may identify the first training image as the training image group for the neural network model corresponding to the identified loss value from among the plurality of neural network models. For example, when the second neural network model 420 is identified as the neural network model corresponding to the loss value having the smallest size, the processor 120 may identify the first training image as the second training image group for the second neural network model.

The processor 120 may then train the neural network model by inputting a plurality of training images included in the training image group corresponding to one of the plurality of neural network models to one of the plurality of neural network models, according to an embodiment. For example, when the first training image is included in the second training image, the processor 120 may train the second neural network model by inputting images in the second training image group including the first training image to the second neural network model.

Accordingly, the plurality of neural network models are trained with the training image that minimizes the loss value corresponding to each of the plurality of neural network models, thereby improving the training performance.

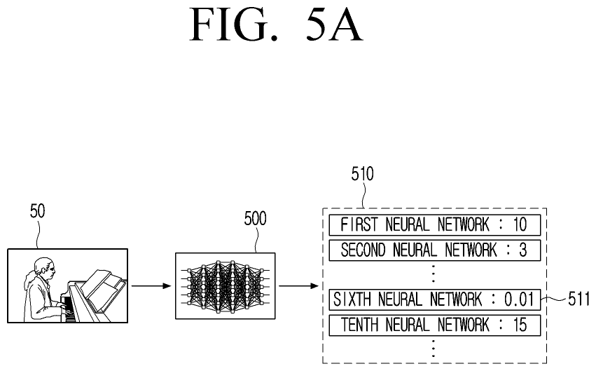

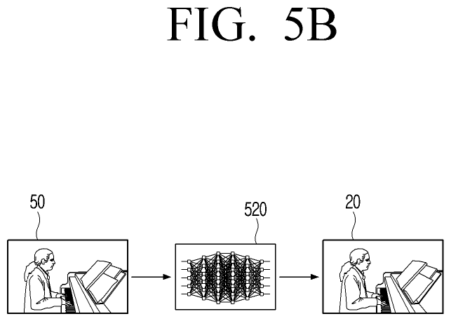

FIGS. 5A and 5B are views provided to explain a method of obtaining an image of which quality has been improved through a trained neural network model according to an embodiment.

According to an embodiment, the memory 110 may further include a neural network model for predicting a loss value. Here, the neural network model for predicting loss values is different from the neural network model for performing the image classification and image enhancement functions described above, and is a neural network model that receives an image and outputs the loss value (e.g., first loss value or second loss value) corresponding to each of the plurality of neural network models described above.

Referring to FIG. 5A, according to an embodiment, the processor 120 may input an input image 50 to a neural network model 500 for predicting a loss value to obtain a loss value 510 corresponding to each of the plurality of neural network models. Subsequently, according to an embodiment, the processor 120 may identify a loss value having the smallest size from among the obtained loss values. According to an embodiment, the processor 120 may identify a loss value 511 having the smallest size from among the obtained plurality of loss values 510.

Subsequently, referring to FIG. 5B, according to an embodiment, the processor 120 may obtain an image with improved quality by inputting the input image to the neural network model corresponding to the identified loss value from among the plurality of neural network models. In one example, the processor 120 may identify a sixth neural network model 520 corresponding to the identified loss value 511 having the smallest size, and obtain an image 20 with improved quality by inputting the input image 50 to the identified sixth neural network model 520.

The neural network model for predicting a loss value may be trained based on a training image and the loss value of the training image for each of the plurality of neural network models. For example, in the case of FIG. 4, the processor 120 may input the first training image and a plurality of loss values 413 to 433 corresponding to the first training image to the neural network model for predicting a loss value to train the neural network model.

According to an embodiment, the processor 120 may identify a neural network model corresponding to the input image from among the plurality of neural network models, input the input image to the neural network model to obtain an image with improved quality, and control the display to display the image with improved quality. In one example, the processor 120 may input the input image 50 to the neural network model for predicting a loss value to obtain a plurality of loss values 510 corresponding to the input image 50, and identify the sixth neural network model having the smallest loss value based thereon. Subsequently, the processor 120 may input the input image 50 into the sixth neural network model 520 to obtain the image 20 with improved quality, and may control the display to display the obtained image 20. Accordingly, the electronic device 100 may provide the image with improved quality to a user.

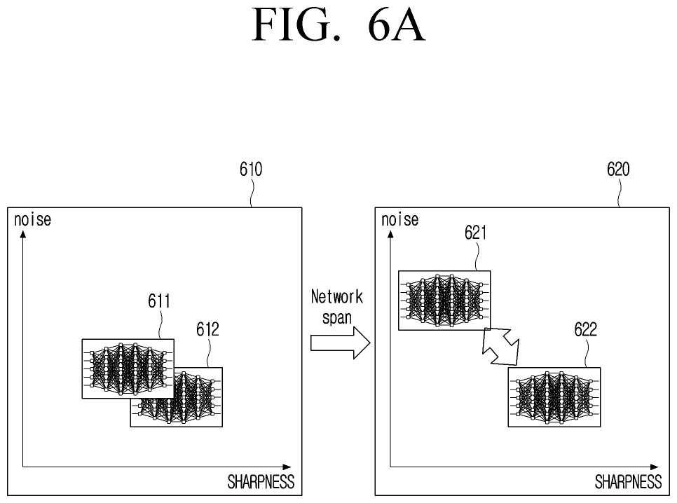

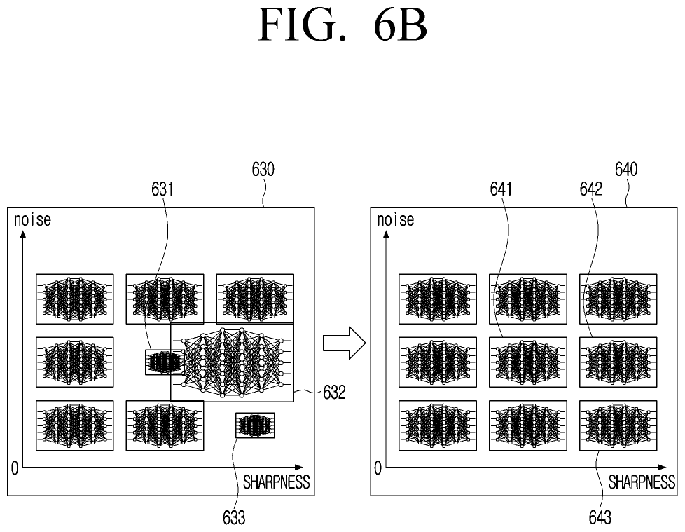

FIGS. 6A and 6B are views provided to explain a method of training a plurality of neural network models according to an embodiment.

Referring to FIG. 6A, according to an embodiment, the plurality of neural network models may be trained to reduce the L1 loss value, the GAN loss value, and the span loss value. In this case, since it is trained that the error between the output image of a neural network model and the correct image (ground truth) is reduced, the output image of the neural network model becomes close to the correct image (ground truth).

Since the span loss value is a function with a negative sign, it is trained that the error between the output image of one of the neural network models 611 and the output image of another one of the neural network models 612 increases. Accordingly, the output image of one of the neural network models 611 and the output image of another one of the neural network models 612 change as training progresses.

For example, as it is trained that the error between the output image of one of the plurality of neural network models and the output image of another one of the neural network models increases, the difference between the output images increases further after training 620 than before training 610.

Referring to FIG. 6B, according to an embodiment, the processor 120 may train the plurality of neural network models such that the difference in the output images obtained through each of the plurality of neural network models increases. In one example, the processor 120 may train the plurality of neural network models such that when the difference in the quality (e.g., sharpness or noise) of output images 631 and 632 output through each of the plurality of neural network models is less than a preset value, the difference in the quality of the output images 631 and 632 obtained through each of the plurality of neural network models increases. Accordingly, the difference in the quality (e.g., sharpness or noise) of output images 641 and 642 obtained through each of the plurality of neural network models increases, and each of the plurality of neural network models outputs images with different quality.

According to an embodiment, the plurality of neural network models may be trained to reduce the L1 loss value and the GAN loss value, and the error between the output image of the neural network models and the correct image (ground truth) is reduced. Accordingly, the output image of a neural network model becomes close to the correct image (ground truth), and the electronic device 100 may obtain a neural network model 643 with improved performance compared to a neural network model 633 before training.

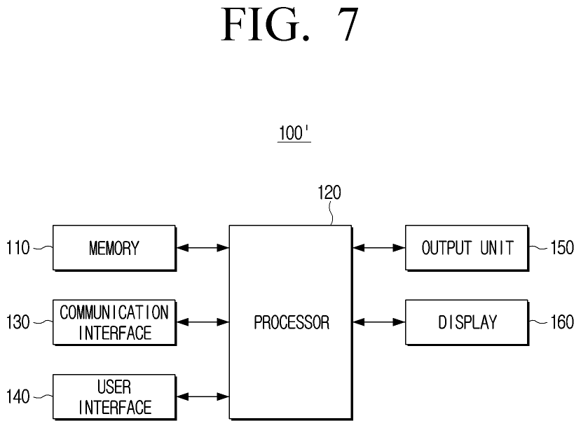

FIG. 7 is a view provided to explain detailed configuration of an electronic device according to an embodiment.

Referring to FIG. 7, an electronic device 100′ includes the memory 110, the processor 120, a communication interface 130, a user interface 140, an output unit 150, and a display 160. For additional implementation details of the configuration shown in FIG. 7, reference may be made to the descriptions of FIG. 2.

The communication interface 130 may receive various types of contents. For example, the communication interface 130 may receive signals in a streaming or download method from an external device (e.g., source device), an external storage medium (e.g., USB memory), an external server (e.g., web hard), or the like through communication methods such as AP-based Wi-Fi (Wi-Fi, Wireless LAN Network), Bluetooth, Zigbee, wired/wireless Local Area Network (LAN), Wide Area Network (WAN), Ethernet, IEEE 1394, High-Definition Multimedia Interface (HDMI), Universal Serial Bus (USB), Mobile High-Definition Link (MHL), Audio Engineering Society/European Broadcasting Union (AES/EBU), Optical, Coaxial, etc.

According to an embodiment, the processor 120 may obtain a first periodic function corresponding to a first time interval and a second periodic function corresponding to a second time interval from an external device via the communication interface 130, and update an activation function using the obtained first periodic function and second periodic function.

The user interface 140 may be implemented as a device such as buttons, a touch pad, a mouse, and a keyboard, or may be implemented as a touch screen, a remote control transceiver, or the like, which may also perform the display function and manipulation input function described above. The remote control transceiver may receive/transmit remote control signals from/to an external remote control device via at least one communication method from among infrared communication, Bluetooth communication, or Wi-Fi communication.

The output unit 150 outputs an acoustic signal. For example, the output unit 150 may convert a digital acoustic signal processed by the processor 120 to an analog acoustic signal and amplify and output the same. For example, the output unit 150 may include at least one speaker unit, a D/A converter, an audio amplifier, or the like, capable of outputting at least one channel. According to an embodiment, the output unit 150 may be implemented to output various multi-channel acoustic signals. In this case, the processor 120 may control the output unit 150 to output the input acoustic signal by performing enhancement processing corresponding to the enhancement processing of the input image. For example, the processor 120 may convert the input 2-channel acoustic signal into a virtual multi-channel (e.g., 5.1 channel) acoustic signal, recognize the position where the electronic device 100′ is placed and process the acoustic signal into a stereoscopic acoustic signal optimized for the space, or provide an optimized acoustic signal according to the type of the input image (e.g., content genre).

The display 160 may be implemented as a display including a self-light emitting element or a display including a non self-light emitting element and a backlight. For example, the display 160 may be implemented in various types of displays such as a liquid crystal display (LCD), an organic light emitting diode (OLED) display, a light emitting diode (LED) display, a micro light emitting diode (micro LED) display, a mini LED display, a plasma display panel (PDP), a quantum dot (QD) display, a quantum dot light-emitting diode (QLED) display. The display 160 may also include a driving circuit, a backlight unit and the like, which may be implemented in a form such as an a-si thin film transistor (TFT), a low temperature poly silicon (LTPS) TFT, or an organic TFT (OTFT). The display 160 may be implemented as a touch screen combined with a touch sensor, a flexible display, a rollable display, a three-dimensional (3D) display, a display in which a plurality of display modules are physically connected with each other, or the like. The processor 120 may control the display 160 to output an acquired output image according to the various embodiments described above. Here, the output image may be a high-resolution image of 4K, 8K or higher.

According to an embodiment, the processor 120 may identify a neural network model corresponding to the input image from among the plurality of neural network models, input the input image into the neural network model to obtain an image with improved quality, and control the display 160 to display the image with improved quality.

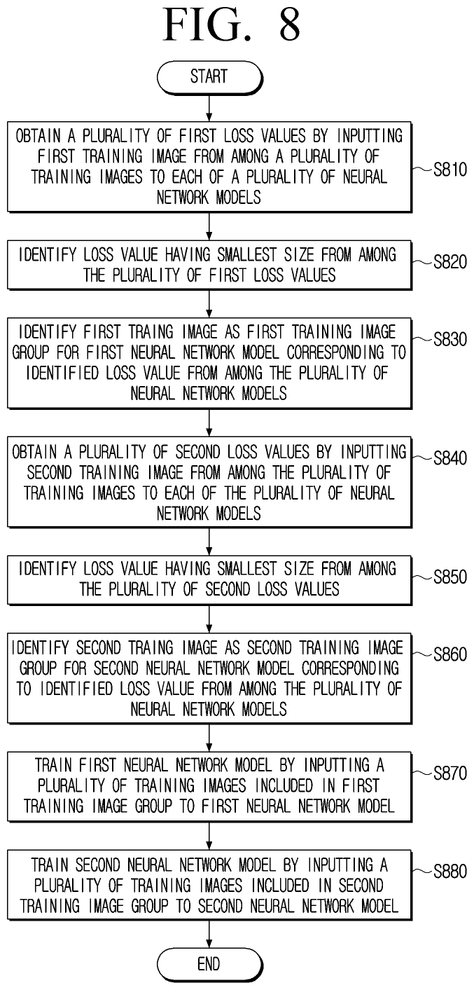

FIG. 8 is a flowchart provided to explain a controlling method of an electronic device according to an embodiment.

According to an electronic device storing information about a plurality of trained neural network models shown in FIG. 8, a first training image from among a plurality of training images is input to each of the plurality of neural network models to obtain a plurality of first loss values (S810).

Here, step S810 may include obtaining a plurality of first raw loss values of different types by inputting the first training image to one of the plurality of neural network models, obtaining one of the plurality of first raw loss values by applying a preset weight to each of the plurality of first raw loss values, obtaining a plurality of first raw loss values of different types by inputting the first training image to another one of the plurality of neural network models, and obtaining another one of the plurality of first raw loss values by applying a preset weight to each of the plurality of first raw loss values.

Next, the controlling method includes identifying a loss value having the smallest size from among the plurality of first loss values (S820).

The controlling method then includes identifying a first training image as a first training image group for a first neural network model corresponding to the identified loss value among the plurality of neural network models (S830).

The controlling method then include inputting a second training image from among a plurality of training images to each of the plurality of neural network models to obtain a plurality of second loss values (S840).

Next, the controlling method includes identifying a loss value having the smallest size from among the plurality of second loss values (S850).

The controlling method then includes identifying the second training image as a second training image group for a second neural network model corresponding to the identified loss value from among the plurality of neural network models (S860).

Subsequently, the controlling method includes inputting a plurality of training images included in the first training image group to the first neural network model to train the first neural network model (S870).

The controlling method then include inputting the plurality of training images included in the second training image group to the second neural network model to train the second neural network model (S880).

Here, steps S810 and S840 may include obtaining a plurality of first raw loss values of different types by inputting a first training image to one of a plurality of neural network models, obtaining a first intermediate loss value by applying a first weight to each of the plurality of first raw loss values, obtaining a plurality of second raw loss values of different types by inputting a second training image to one of the plurality of neural network models, obtaining a second intermediate loss value by applying a second weight to each of the plurality of second raw loss values, normalizing each of the first intermediate loss value and the second intermediate loss value based on the first intermediate loss value and the second intermediate loss value, obtaining a plurality of first loss values based on the normalized first intermediate loss value, and obtaining a plurality of second loss values based on the normalized second intermediate loss value.

Here, the normalizing step may include normalizing each of the first intermediate loss value and the second intermediate loss value based on the loss obtained based on each of the first training image and the second training image.

Further, the plurality of first raw loss values of different types may include a first L1 loss value and a first GAN loss value, and the plurality of second raw loss values of different types may include a second L1 loss value and a second GAN loss value.

Here, the step of obtaining the first intermediate loss value may include obtaining the first intermediate loss value by weighting the first L1 loss value and the first GAN loss value based on the first weight, and the step of obtaining the second intermediate loss value may include obtaining the second intermediate loss value by weighting the second L1 loss value and the second GAN loss value based on the second weight.

Further, the plurality of first raw loss values of different types may include a first L1 loss value, a first GAN loss value, and a first span loss value, and the plurality of second raw loss values of different types may include a second L1 loss value, a second GAN loss value, and a second span loss value.

Here, the step of obtaining the first intermediate loss value may include obtaining the first intermediate loss value by weighting the first L1 loss value, the first GAN loss value, and the first span loss value based on a first weight, and the step of obtaining the second intermediate loss value may include obtaining the second intermediate loss value by weighting the second L1 loss value, the second GAN loss value, and the second span loss value based on a second weight, and the first span loss value and the second span loss value may be calculated based on a loss value between an output image of one of the plurality of neural network models and an output image of another one of the plurality of neural network models.

Here, the plurality of neural network models may be trained to reduce the L1 loss value and the GAN loss value, and increase the span loss value.

In addition, the plurality of neural network models may be neural network models that perform image classification and image enhancement functions, and the controlling method may further include obtaining a loss value corresponding to each of the plurality of neural network models by inputting the input image to a neural network model for predicting a loss value, identifying a loss value having the smallest size from among the obtained loss values, and obtaining an image with improved quality by inputting the input image into a neural network model corresponding to the identified loss value from among the plurality of neural network models, and the neural network model for predicting a loss value may be trained based on a training image and the loss value of the training image for each of the plurality of neural network models.

Here, the controlling method may further include identifying a neural network model corresponding to the input image from among the plurality of neural network models, obtaining an image with improved quality by inputting the input image to the neural network model, and displaying the image with improved quality.

According to various embodiments described above, a plurality of training images may be clustered into a plurality of training image groups for each neural network model based on a loss value, thereby increasing the training effect of the neural network models and improving the performance thereof.

The methods according to various embodiments of the present disclosure may be implemented in the form of an application that can be installed on an existing electronic device. The methods according to various embodiments of the present disclosure may be performed using a deep learning-based trained neural network (or deeply trained neural network), e.g., a learning network model. Further, the methods according to various embodiments of the present disclosure may be implemented by software upgrade to the existing electronic devices, or by hardware upgrade alone. Further, the various embodiments of the disclosure described above may also be performed through an embedded server provided in the electronic device, or an external server of the electronic device.

The above-described various embodiments may be implemented as software including instructions stored in machine-readable storage media, which can be read by machine (e.g.: computer). The machine refers to a device that calls instructions stored in a storage medium, and can operate according to the called instructions, and the device may include a display device (e.g.: display device (A)) according to the aforementioned embodiments. In case an instruction is executed by a processor, the processor may perform a function corresponding to the instruction by itself, or by using other components under its control. The instruction may include a code that is generated or executed by a compiler or an interpreter. The machine-readable storage medium may be provided in the form of a non-transitory storage medium. Here, the term ‘non-transitory’ means that the storage medium is tangible without including a signal, and does not distinguish whether data are semi-permanently or temporarily stored in the storage medium.

According to an embodiment, the above-described methods according to the various embodiments may be included and provided in a computer program product. The computer program product may be traded as a product between a seller and a purchaser. The computer program product may be distributed in a form of a storage medium (e.g., a compact disc read only memory (CD-ROM)) that may be read by the machine or online through an application store (e.g., PlayStore™). In case of the online distribution, at least a portion of the computer program product may be at least temporarily stored in a storage medium such as memory of a server of a manufacturer, a server of an application store, or a relay server or be temporarily generated.

In addition, the components (e.g., modules or programs) according to various embodiments described above may include a single entity or a plurality of entities, and other sub-components may be further included in the various embodiments. Some components (e.g., modules or programs) may be integrated into one entity and perform the same or similar functions performed by each corresponding component prior to integration. Operations performed by the modules, the programs, or the other components according to the various embodiments may be executed in a sequential manner, a parallel manner, an iterative manner, or a heuristic manner, or at least some of the operations may be performed in a different order, or other operations may be added.

Although example embodiments of the present disclosure have been shown and described above, the disclosure is not limited to the embodiments described above, and various modifications may be made by one of ordinary skill in the art without departing from the spirit of the disclosure as claimed in the claims, and such modifications are not to be understood in isolation from the technical ideas or prospect of the disclosure.

What is claimed is:

1. An electronic device for training a neural network model performing image enhancement, the electronic device comprising:
memory storing instructions; and
one or more processors configured to execute the instructions,
wherein the instructions, when executed by the one or more processors, cause the electronic device to:
obtain a plurality of first loss values by inputting a first training image from among a first plurality of training images into a plurality of neural network models;
identify a loss value having a smallest size from among the plurality of first loss values;
identify the first training image as being included in a first training image group for a first neural network model, corresponding to the loss value identified from among the plurality of first loss values, from among the plurality of neural network models;
obtain a plurality of second loss values by inputting a second training image from among the first plurality of training images into the plurality of neural network models;
identify a loss value having a smallest size from among the plurality of second loss values;
identify the second training image as being included in a second training image group for a second neural network model, corresponding to the loss value identified from among the plurality of second loss values, from among the plurality of neural network models; and
train the first neural network model by inputting a second plurality of training images included in the first training image group into the first neural network model, and train the second neural network model by inputting a third plurality of training images included in the second training image group into the second neural network model.

2. The electronic device as claimed in claim 1, wherein the instructions, when executed by the one or more processors, further cause the electronic device to:
obtain a first plurality of first raw loss values of different types by inputting the first training image into a third neural network model from among the plurality of neural network models;
obtain a third loss value from among the plurality of first loss values by applying a first preset weight to the first plurality of first raw loss values;
obtain a second plurality of first raw loss values of different types by inputting the first training image into a fourth neural network model from among the plurality of neural network models; and
obtain a fourth loss value from among the plurality of first loss values by applying a second preset weight to each of the second plurality of first raw loss values.

3. The electronic device as claimed in claim 1, wherein the instructions, when executed by the one or more processors, further cause the electronic device to:
obtain a first plurality of first raw loss values of different types by inputting the first training image into a third neural network model from among the plurality of neural network models;
obtain a first intermediate loss value by applying a first weight corresponding to a fourth neural network model from among the plurality of neural network models to the first plurality of first raw loss values;
obtain a first plurality of second raw loss values of different types by inputting the second training image into a fifth neural network model from among the plurality of neural network models;
obtain a second intermediate loss value by applying a second weight corresponding to a sixth neural network model from among the plurality of neural network models to the first plurality of second raw loss values;
obtain a normalized first intermediate loss value and a normalized second intermediate loss value by normalizing each of the first intermediate loss value and the second intermediate loss value based on the first intermediate loss value and the second intermediate loss value;
obtain the plurality of first loss values based on the normalized first intermediate loss value; and
obtain the plurality of second loss values based on the normalized second intermediate loss value.

4. The electronic device as claimed in claim 3, wherein the instructions, when executed by the one or more processors, further cause the electronic device to normalize each of the first intermediate loss value and the second intermediate loss value based on a distribution shape of each of the first intermediate loss value and the second intermediate loss value.

5. The electronic device as claimed in claim 3, wherein the first plurality of first raw loss values of different types comprise a first L1 loss value and a first Generative Adversarial Networks (GAN) loss value,
wherein the first plurality of second raw loss values of different types include a second L1 loss value and a second GAN loss value, and
wherein the instructions, when executed by the one or more processors, further cause the electronic device to:
obtain the first intermediate loss value by weighting the first L1 loss value and the first GAN loss value based on a third weight corresponding to a seventh neural network model from among the plurality of neural network models; and
obtain the second intermediate loss value by weighting the second L1 loss value and the second GAN loss value based on a fourth weight corresponding to an eighth neural network model from among the plurality of neural network models.

6. The electronic device as claimed in claim 3, wherein the first plurality of first raw loss values of different types include a first L1 loss value, a first GAN loss value, and a first span loss value,
wherein the first plurality of second raw loss values of different types include a second L1 loss value, a second GAN loss value, and a second span loss value,
wherein the instructions, when executed by the one or more processors, further cause the electronic device to:
obtain the first intermediate loss value by weighting the first L1 loss value, the first GAN loss value, and the first span loss value based on a third weight corresponding to a seventh neural network model from among the plurality of neural network models; and
obtain the second intermediate loss value by weighting the second L1 loss value, the second GAN loss value, and the second span loss value based on a fourth weight corresponding to an eighth neural network model from among the plurality of neural network models, and
wherein the first span loss value and the second span loss value are calculated based on a loss value between a first output image of a ninth neural network model from among the plurality of neural network models and a second output image of a tenth neural network model from among the plurality of neural network models.

7. The electronic device as claimed in claim 6, wherein the plurality of neural network models are trained to reduce loss values obtained based on each of the first training image and the second training image.

8. The electronic device as claimed in claim 1, wherein the plurality of neural network models are models that perform image classification and image enhancement,
wherein the instructions, when executed by the one or more processors, further cause the electronic device to:
obtain a first plurality of loss values corresponding to the plurality of neural network models by inputting an input image into a third neural network model for predicting a loss value;
identify a third loss value having a smallest size from among the first plurality of loss values; and
obtain an image by inputting the input image into a fourth neural network model corresponding to the third loss value from among the plurality of neural network models,
wherein the third neural network model for predicting the loss value is trained based on a training image and a second plurality of loss values of the training image for the plurality of neural network models.

9. The electronic device as claimed in claim 1, further comprising a display,
wherein the instructions, when executed by the one or more processors, further cause the electronic device to:
identify a third neural network model corresponding to the input image from among the plurality of neural network models;
obtain an image by inputting the input image to the third neural network model; and
control the display to display the image.

10. A method of controlling an electronic device for training a neural network model performing image enhancement, the method comprising:
obtaining a plurality of first loss values by inputting a first training image from among a first plurality of training images into a plurality of neural network models;
identifying a loss value having a smallest size from among the plurality of first loss values;
identifying the first training image as being included in a first training image group for a first neural network model, corresponding to the loss value identified from among the plurality of first loss values, from among the plurality of neural network models;
obtaining a plurality of loss values by inputting a second training image from among the first plurality of training images into the plurality of neural network models;
identifying a second loss value having a smallest size from among the plurality of second loss values;
identifying the second training image as being included in a second training image group for a second neural network model, corresponding to the loss value identified from among the plurality of second loss values, from among the plurality of neural network models;
training the first neural network model by inputting a second plurality of training images included in the first training image group into the first neural network model; and
training the second neural network model by inputting a third plurality of training images included in the second training image group into the second neural network model.

11. The method as claimed in claim 10, wherein the obtaining the plurality of first loss values comprises:
obtaining a first plurality of first raw loss values of different types by inputting the first training image into a third neural network model from among the plurality of neural network models;
obtaining a third loss value from among the plurality of first loss values by applying a first preset weight to the first plurality of first raw loss values;
obtaining a second plurality of first raw loss values of different types by inputting the first training image into a fourth neural network model from among the plurality of neural network models; and
obtaining a fourth loss value from among the plurality of first loss values by applying a second preset weight to each of the second plurality of first raw loss values.

12. The method as claimed in claim 10, wherein the obtaining the plurality of first loss values and the plurality of second loss values comprises:
obtaining a first plurality of first raw loss values of different types by inputting the first training image into a third neural network model from among the plurality of neural network models;
obtaining a first intermediate loss value by applying a first weight corresponding to a fourth neural network model from among the plurality of neural network models to the first plurality of first raw loss values;
obtaining a first plurality of second raw loss values of different types by inputting the second training image into a fifth neural network model from among the plurality of neural network models;
obtaining a second intermediate loss value by applying a second weight corresponding to a sixth neural network model from among the plurality of neural network models to the first plurality of second raw loss values;
obtaining a normalized first intermediate loss value and a normalized second intermediate loss value by normalizing each of the first intermediate loss value and the second intermediate loss value based on the first intermediate loss value and the second intermediate loss value; and
obtaining the plurality of first loss values based on the normalized first intermediate loss value, and obtaining the plurality of second loss values based on the normalized second intermediate loss value.

13. The method as claimed in claim 12, wherein the normalizing comprises normalizing each of the first intermediate loss value and the second intermediate loss value based on a distribution shape of each of the first intermediate loss value and the second intermediate loss value.

14. The method as claimed in claim 12, wherein the first plurality of first raw loss values of different types comprise a first L1 loss value and a first Generative Adversarial Networks (GAN) loss value,
wherein the first plurality of second raw loss values of different types include a second L1 loss value and a second GAN loss value,
wherein the obtaining the first intermediate loss value comprises obtaining the first intermediate loss value by weighting the first L1 loss value and the first GAN loss value based on a third weight corresponding to a seventh neural network model from among the plurality of neural network models, and
wherein the obtaining the second intermediate loss value comprises obtaining the second intermediate loss value by weighting the second L1 loss value and the second GAN loss value based on a fourth weight corresponding to an eighth neural network model from among the plurality of neural network models.

15. A non-transitory computer-readable recording medium having instructions recorded thereon, that, when executed by one or more processors, causes the one or more processors to:
obtain a plurality of first loss values by inputting a first training image from among a first plurality of training images into a plurality of neural network models;
identify a loss value having a smallest size from among the plurality of first loss values;
identify the first training image as being included in a first training image group for a first neural network model, corresponding to the loss value identified from among the plurality of first loss values, from among the plurality of neural network models;
obtain a plurality of second loss values by inputting a second training image from among the first plurality of training images into the plurality of neural network models;
identify a loss value having a smallest size from among the plurality of second loss values;
identify the second training image as being included in a second training image group for a second neural network model, corresponding to the loss value identified from among the plurality of second loss values, from among the plurality of neural network models; and
train the first neural network model by inputting a second plurality of training images included in the first training image group into the first neural network model, and train the second neural network model by inputting a third plurality of training images included in the second training image group into the second neural network model.

16. The non-transitory computer-readable recording medium as claimed in claim 15, wherein the instructions, when executed by the one or more processors, further cause the one or more processors to:
obtain a first plurality of first raw loss values of different types by inputting the first training image into a third neural network model from among the plurality of neural network models;
obtain a third loss value from among the plurality of first loss values by applying a first preset weight to the first plurality of first raw loss values;
obtain a second plurality of first raw loss values of different types by inputting the first training image into a fourth neural network model from among the plurality of neural network models; and
obtain a fourth loss value from among the plurality of first loss values by applying a second preset weight to each of the second plurality of first raw loss values.

17. The non-transitory computer-readable recording medium as claimed in claim 15, wherein the instructions, when executed by the one or more processors, further cause the one or more processors to:
obtain a first plurality of first raw loss values of different types by inputting the first training image into a third neural network model from among the plurality of neural network models;
obtain a first intermediate loss value by applying a first weight corresponding to a fourth neural network model from among the plurality of neural network models to the first plurality of first raw loss values;
obtain a first plurality of second raw loss values of different types by inputting the second training image into a fifth neural network model from among the plurality of neural network models;
obtain a second intermediate loss value by applying a second weight corresponding to a sixth neural network model from among the plurality of neural network models to the first plurality of second raw loss values;
obtain a normalized first intermediate loss value and a normalized second intermediate loss value by normalizing each of the first intermediate loss value and the second intermediate loss value based on the first intermediate loss value and the second intermediate loss value;
obtain the plurality of first loss values based on the normalized first intermediate loss value; and
obtain the plurality of second loss values based on the normalized second intermediate loss value.

18. The non-transitory computer-readable recording medium as claimed in claim 17, wherein the instructions, when executed by the one or more processors, further cause the one or more processors to normalize each of the first intermediate loss value and the second intermediate loss value based on a distribution shape of each of the first intermediate loss value and the second intermediate loss value.

19. The non-transitory computer-readable recording medium as claimed in claim 17, wherein the first plurality of first raw loss values of different types comprise a first L1 loss value and a first Generative Adversarial Networks (GAN) loss value,
wherein the first plurality of second raw loss values of different types include a second L1 loss value and a second GAN loss value, and
wherein the instructions, when executed by the one or more processors, further cause the one or more processors to:
obtain the first intermediate loss value by weighting the first L1 loss value and the first GAN loss value based on a third weight corresponding to a seventh neural network model from among the plurality of neural network models; and
obtain the second intermediate loss value by weighting the second L1 loss value and the second GAN loss value based on a fourth weight corresponding to an eighth neural network model from among the plurality of neural network models.

20. The non-transitory computer-readable recording medium as claimed in claim 17, wherein the first plurality of first raw loss values of different types include a first L1 loss value, a first GAN loss value, and a first span loss value,
wherein the first plurality of second raw loss values of different types include a second L1 loss value, a second GAN loss value, and a second span loss value,
wherein the instructions, when executed by the one or more processors, further cause the one or more processors to:
obtain the first intermediate loss value by weighting the first L1 loss value, the first GAN loss value, and the first span loss value based on a third weight corresponding to a seventh neural network model from among the plurality of neural network models; and
obtain the second intermediate loss value by weighting the second L1 loss value, the second GAN loss value, and the second span loss value based on a fourth weight corresponding to an eighth neural network model from among the plurality of neural network models, and
wherein the first span loss value and the second span loss value are calculated based on a loss value between a first output image of a ninth neural network model from among the plurality of neural network models and a second output image of a tenth neural network model from among the plurality of neural network models.
